(19) United States
(12) Patent Application Publication
(10) Pub. No.: US 2026/0221686 A1
(43) Pub. Date: Jul. 30, 2026

(54) Twisted Pair Data Connector

(71) Applicants: APTIV CONNECTION SYSTEMS (NANTONG) LTD., Jiangsu (CH); APTIV ELECTRICAL CENTERS (SHANGHAI) CO. LTD., Shanghai (CN)

(72) Inventors: Mei YE, Shanghai (CN); Liangtao ZHU, Shanghai (CN); Haifei GUAN, Shanghai (CN)

(21) Appl. No.: 19/459,191

(22) Filed: Jan. 26, 2026

(30) Foreign Application Priority Data
Jan. 24, 2025 (CN) 202510125478.5

(51) Int. Cl. H01R 13/52

(52) U.S. Cl. CPC H01R 13/52; H01R 2201/26

(57) ABSTRACT

This disclosure discloses a twisted pair data connector including a front shell assembly. The front shell assembly includes a terminal channel defined therein. The twisted pair data connector further includes a rear cover assembly. The rear cover assembly is to be assembled with the front shell assembly to form an outer plastic shell structure. The outer plastic shell structure has a cable channel defined therein. The cable channel forms an angle with the terminal channel. The twisted pair data connector also includes a rear cover sealing body that is provided at the joint between the front shell assembly and the rear cover assembly.

### CROSS-REFERENCE TO RELATED DISCLOSURE

This disclosure claims the benefit of and priority to Chinese Patent Disclosure 202510125478.5 on January 24, 2025, the contents of which are incorporated by reference herein.

### TECHNICAL FIELD OF THE INVENTION

This disclosure relates to the technical field of connector technology, particularly, relating to twisted pair data connector used in automotive electrical and electronic architecture.

### BACKGROUND

With the rapid development of intelligent and networked automobiles, the demand for high-speed data transmission in vehicles is becoming increasingly urgent. Twisted pair data connectors are commonly used for high-speed data transmission. Traditional twisted pair data connectors do not have waterproof function, which makes them unable to be used in certain specific disclosure scenarios. In addition, there is further challenge to design of connector configuration for waterproof functions in angled twisted pair data connectors (i.e., connectors with a 90 degree or other angle between the insertion direction and the incoming direction).

To solve the technical problem described above, this disclosure presents a twisted pair data connector including a front shell assembly. The front shell assembly has a terminal channel defined therein. The twisted pair data connector also includes a rear cover assembly. The rear cover assembly is to be assembled with the front shell assembly to form an outer plastic shell structure. The outer plastic shell structure has a cable channel defined therein. The cable channel forms an angle with the terminal channel. A rear cover sealing body is provided at the joint between the front shell assembly and the rear cover assembly.

In the above solution of twisted pair data connector, as an optional implementation, the rear cover sealing body is installed and positioned within the front shell assembly.

In the twisted pair data connector, as an optional implementation, the front shell assembly comprises an insulation housing and an integral seal, and the rear cover sealing body forms a part of the integrated sealing member.

In the twisted pair data connector, as an optional implementation, the integral seal comprises mating-end sealing body arranged in the terminal channel, a rear cover sealing body, and a connecting part connecting the mating-end sealing body and the rear cover sealing body.

In the twisted pair data connector, as an optional implementation, the insulation housing and the integral seal are formed by co-molding process, so that the insulation housing and the integrated seal are inseparable from each other.

In the twisted pair data connector, as an optional implementation, the rear cover assembly comprises a rear cover housing, which is to be latched with the insulation housing, and a seal fitting groove is provided on the rear cover housing to receive the rear cover sealing body of the integral seal.

In the twisted pair data connector, as an optional implementation, the twisted pair data connector is a right-angle connector.

In the twisted pair data connector, as an optional implementation, the twisted pair data connector is a female connector.

In the twisted pair data connector, as an optional implementation, the rear cover assembly comprises a rear cavity to accommodate the cable seal.

In the twisted pair data connector, as an optional implementation, the cable seal and the rear cover housing are formed through a co-molding process.

### BRIEF DESCRIPTION OF THE DRAWINGS

In order to provide a clearer explanation of the technical solution in the embodiments of the present disclosure, a brief introduction will be given to the drawings required for the description of the embodiments. It is apparent that the drawings described below are only some embodiments of the present disclosure. For those skilled in the art, other drawings can be obtained based on these drawings without creative labor.

FIG. 1 is a schematic diagram of the structure of a twisted pair data connector according to an embodiment of the present disclosure.

FIG. 2 is a schematic diagram of the exploded structure of the twisted pair data connector in the first perspective of the embodiment of the present disclosure.

FIG. 3 is a schematic diagram of the exploded structure of the twisted pair data connector from the second perspective of the present embodiment.

FIG. 4 is a schematic cross-sectional view of a twisted pair data connector according to an embodiment of the present disclosure.

FIG. 5 is a further exploded view of the front shell assembly in FIGS. 3 and 4.

FIG. 6 is a further exploded structural diagram of the rear cover assembly in FIGS. 3 and 4, with the seal retention cover omitted.

FIG. 7 is a cross-sectional view of the rear cover assembly shown in FIG. 6.

### DETAILED DESCRIPTION

The following will provide a clear and complete description of the technical solution in the embodiments of the present disclosure, in conjunction with the accompanying drawings. Obviously, the described embodiments are only a part of the embodiments of the present disclosure, not all of them. Based on the embodiments in this disclosure, all other embodiments obtained by those skilled in the art without creative labor are within the scope of protection of this disclosure.

In the description of this disclosure, it should be noted that unless otherwise specified and limited, the terms "connected" and "connected" should be broadly understood, for example, they can be fixed connections, detachable connections, or integrated connections; It can be a mechanical connection, an electrical connection, or communication with each other; It can be directly connected or indirectly connected through an intermediate medium, and it can be a connection within two components or an interaction relationship between two components. For ordinary technical personnel in this field, the specific meanings of the above terms in this disclosure can be understood according to the specific situation. In the description of this disclosure, the meaning of ‘multiple’ refers to two or more, unless otherwise specifically limited. In addition, the terms "first" and "second" are only used for descriptive purposes and cannot be understood as indicating or implying relative importance or implying the number of technical features indicated. Thus, the features limited to "first" and "second" may explicitly or implicitly include one or more features.

The following disclosure provides many different implementation methods or examples to achieve different structures of the present disclosure. In order to simplify the disclosure of this disclosure, specific examples of components and settings are described below. Of course, they are only examples and are not intended to limit the scope of this disclosure.

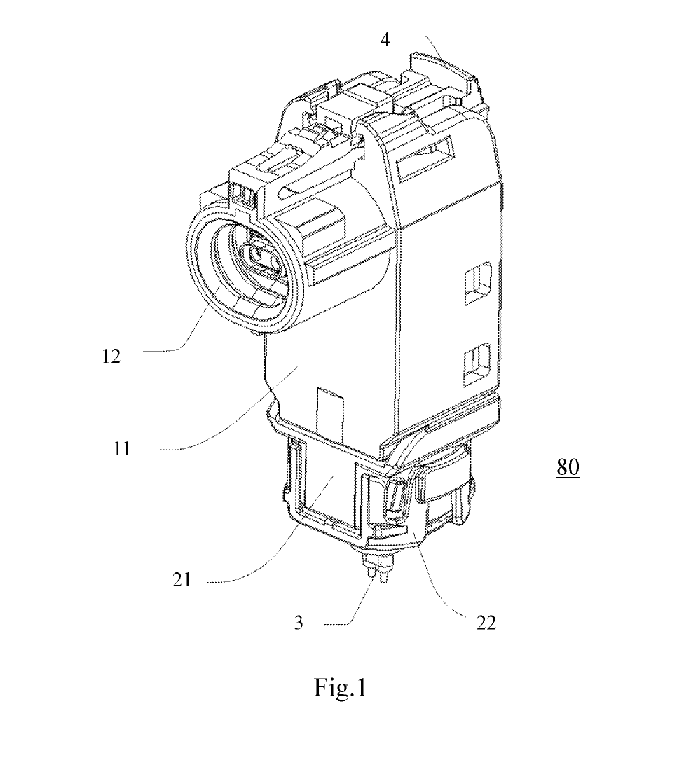

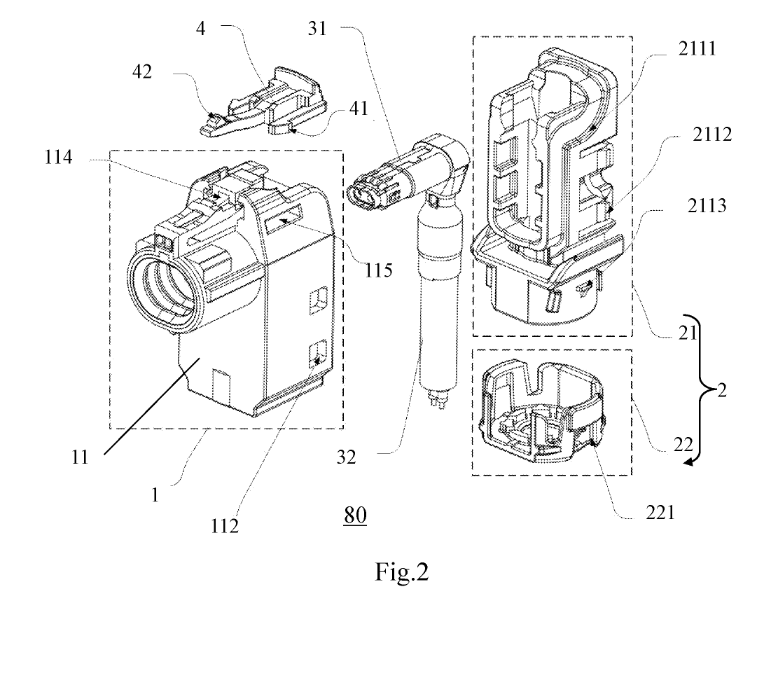

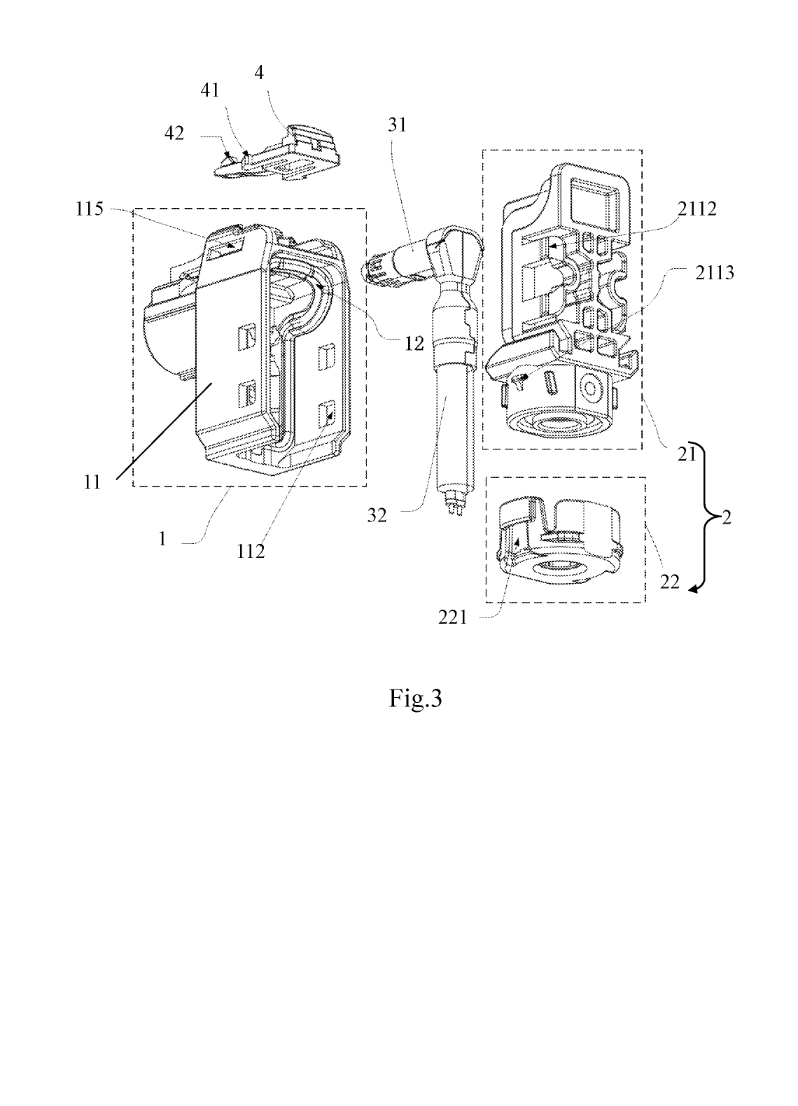

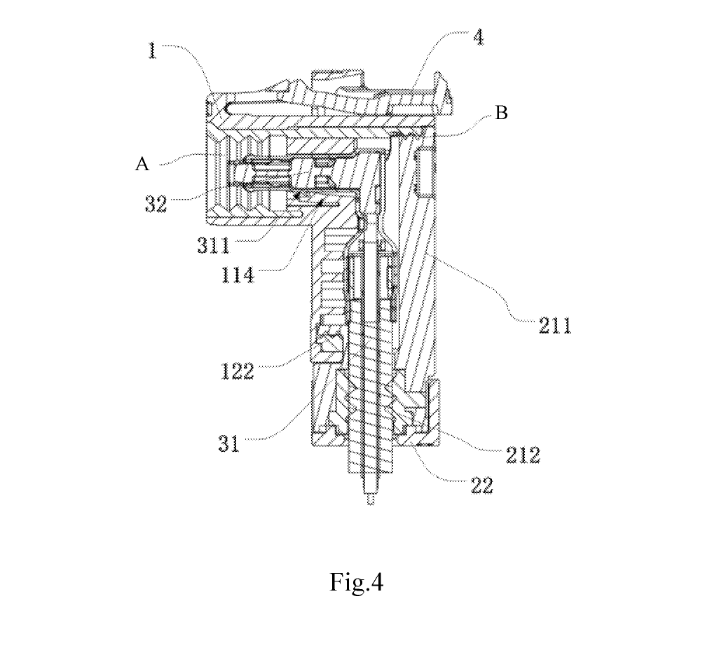

FIG. 1 is a schematic diagram of the three-dimensional structure of a twisted pair data connector 80 according to an embodiment of the present disclosure, FIG. 2 is a schematic diagram of the exploded structure from a first perspective of the twisted pair data connector 80 shown in FIG. 1, FIG. 3 is a schematic diagram of the exploded structure from a second perspective of the twisted pair data connector 80 shown in FIGS. 1 and 4 is a schematic cross-sectional view of the twisted pair data connector 80 shown in FIG. 1.

As shown in FIG. 2-3, the twisted pair data connector 80 generally comprises: a front shell assembly 1, a rear cover assembly 2 (which comprises a rear housing 21 and a seal retention cover 22), a terminal assembly 3 installed in the space formed by the front shell assembly 1 and the rear cover assembly 2, and a connector secondary locking component 4 installed on the front shell assembly 1.

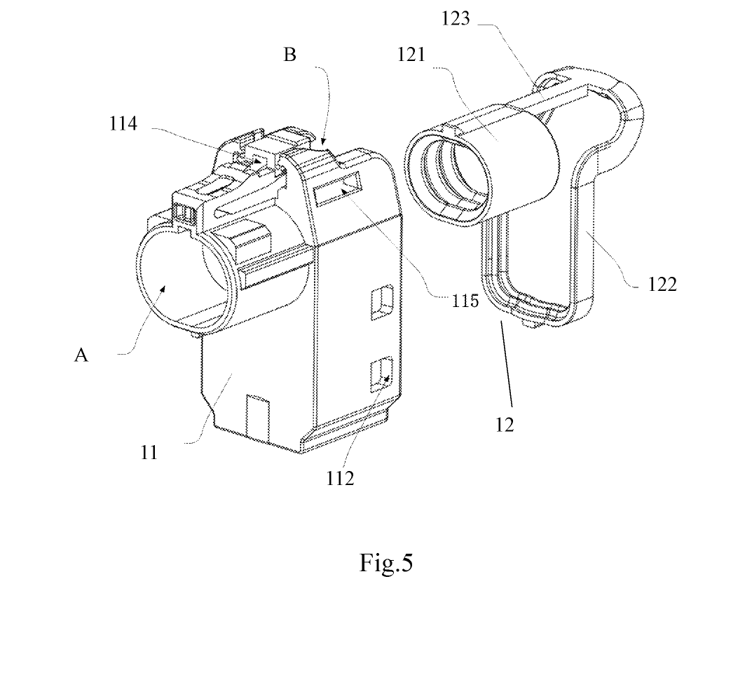

FIG. 5 is a further exploded view of the front shell assembly 1 in FIGS. 3 and 4. As shown in FIG. 5, the front shell assembly 1 further comprises an insulation housing 11 and an integral seal 12, wherein the integral seal 12 is to be assembled in the insulation housing11. The integral seal 12 is a one-piece molded part, which can be made of rubber or other materials with good elasticity.

In the embodiments of FIGS. 1-5, terminal assembly 3 is shown as including a section of twisted pair cable 32 and a twisted pair terminal 31 connected to one end 32 of the twisted pair cable. The twisted pair terminal 31 is shown as a female terminal (used to receive a pair of male pin terminals), therefore, the twisted pair data connector 80 in the embodiment is a female connector. But this disclosure is not limited to this.

Referring to FIG. 4, a terminal channel is defined in the front shell assembly 1. The front shell assembly 1 and the rear cover assembly 2 can be spliced together to obtain an outer plastic shell structure, which defines a cable channel therein. The cable channel and terminal channel form an angle of, for example, 90 degrees.

The insulation housing 11 of the front shell assembly 1 is described below in conjunction with FIG. 2-4. The insulation housing 11 has mating side A and a rear cover side B along the direction of insertion. The integral seal 12 is provided inside the insulation housing 11. As shown in FIG. 5, the integral seal 12 comprises a mating-end sealing body 121, a rear cover sealing body 122, and a connecting part 123. The mating-end sealing body 121 is disposed within a cavity at the mating-end side A, the rear cover sealing body 122 is disposed within a cavity of the rear cover side B, and the connecting part 123 is connected between the mating-end sealing body 121 and the rear cover sealing body 122. The mating-end sealing body 121, the rear cover sealing body 122, and the connecting part 123 are integrally formed. In this embodiment, co-molding technology can be used to place the integral seal 12 inside the insulation housing 11. That is, by using co-molding technology, the insulation housing 11 and the integral seal are inseparable from each other. Therefore, the insulation housing 11 itself constitutes an installation positioning mechanism for the integral seal 12, without the need for a separate seal positioning device.

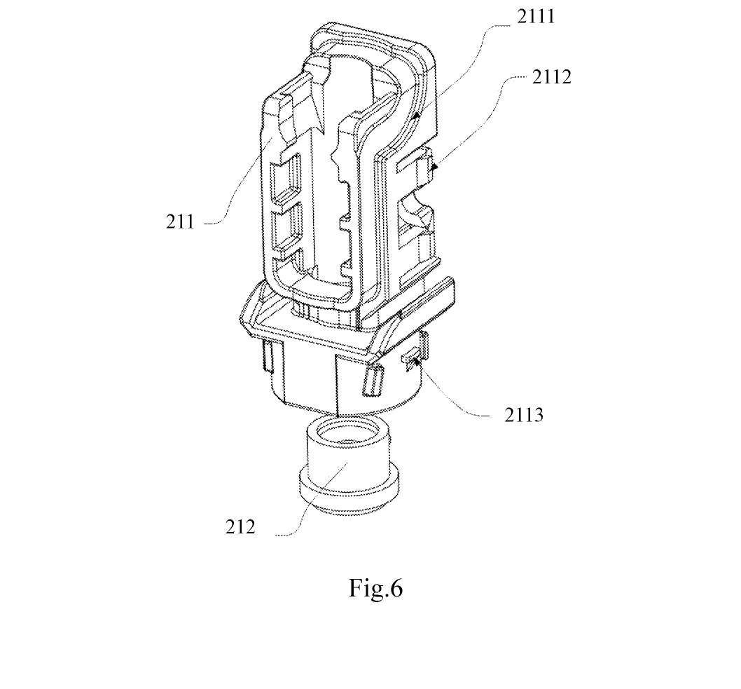

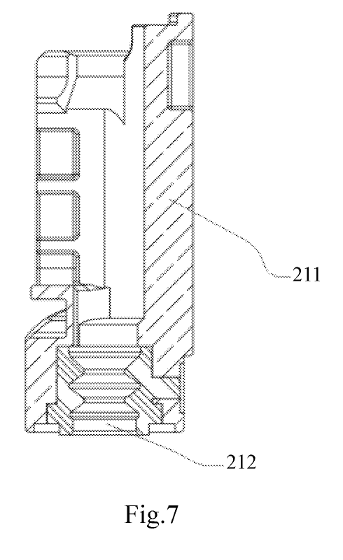

FIG. 6 is a further exploded structural diagram of the rear cover assembly 2 in FIGS. 3-4, and FIG. 7 is a cross-sectional view of the rear cover assembly 2, with the seal retention cover 22 omitted in both FIGS. 6 and 7. Referring further to FIGS. 2-4 and 6-7, the rear cover assembly 2 is used to connect to the sheath assembly 1 and is partially accommodated within the insulating sheath 11. The rear cover sealing body 122 of the integral seal 12 provides a sealing between the rear cover assembly 2 and the insulation housing 11.

Combining FIGS. 2-4 and 6-7, the rear over assembly 2 comprises a rear cover housing 21 and a seal retention cover 22, which are separated from each other but can be assembled together. A seal fitting groove 2111 is provided on the rear cover housing 21 for receiving the rear cover sealing body 122 of the integral seal 12.

The rear cover housing 211 comprises a tail-end for cable entrance, and the cable seal 212 can be installed into tail-end for cable entrance of the rear cover housing 211. The cable seal 212 is installed in a cavity at the tail of the rear cover housing 211. Cable seal 212 is a component separate from integrated seal 12. The seal retention cover 22 can be used to locate and secure the cable seal 212. As an alternative or further implementation, the cable seal 212 can be co-molded with the rear cover housing 211. It can be understood that due to the rear cover housing 211 comprises the cable entrance tail-end it defines a cable channel for twisted pair cable.

The rear cover housing 211 can be referred to as a dressing cover in certain situations.

Referring to FIGS. 5 and 6, the rear cover housing 211 is provided with a first latching structure 2112, and the insulation sheath 11 is provided with a second latching structure 112. The first latching structure 2112 and the second latching structure 112 are interlocked to secure the rear cover housing 211 and the insulation housing 11 together. In this embodiment, the first latching structure 2112 is a latching protrusion, and the second latching structure 112 is a latching hole. In other embodiments, the first latching structure 2112 can also be a latching hole, and the second latching structure 112 can be a latching protrusion.

Referring to FIGS. 3 and 6, the rear cover housing 211 is provided with a third latching structure 2113, and the seal retention cover 22 is provided with a fourth latching structure 221. The third latching structure 2113 and the fourth latching structure 221 are interlocked to secure the rear cover housing 211 and the seal retention cover 22 together. In this embodiment, the third latching structure 2113 is a latching protrusion, and the fourth latching structure 221 is a latching hole. In other embodiments, the third latching structure 2113 may be a latching hole, and the fourth latching structure 221 may be a latching protrusion.

The terminal locking structure on the insulation housing 11 is now described. Referring to FIGS. 3 and 4, a first limiting portion 114 is provided in the terminal channel of the insulation housing 11, and a second limiting portion 311 is provided on the terminal portion 31. The first limiting portion 114 and the second limiting portion 311 cooperate with each other to lock the terminal assembly 3 in the terminal channel of the insulation housing 11. In this embodiment, the first limiting portion 114 comprises an elastic hook, and the second limiting portion 311 comprises a limiting protrusion. The first limiting portion 114 is in contact with the second limiting portion 311 to prevent the terminal assembly 3 from exiting from the terminal channel.

Next, the connector secondary locking structure on the insulation housing 11 is described. Please refer to FIGS. 2 and 3, the twisted pair data connector 80 may further comprises a connector secondary locking component 4. In the relevant field, connector secondary locking component 4 can be referred to as connector position assurance, aka CPA. The connector secondary locking component 4 is used to enhance the retention force between the twisted pair data connector 80 and a mating connector. Particularly, in this embodiment, two lateral sides of the connector secondary locking component 4 are provided with lateral protrusions 41, and limiting slots 115 is formed on the insulation housing 11. The lateral protrusions 41 are to be fitted into the limiting slots 115 to prevent the withdrawal movement of the connector secondary locking component 4. Furthermore, a locking protrusion 41 is provided on the connector secondary locking component 4, and a locking protrusion 42 is to be inserted under the first limiting portion 114 of the connector secondary locking component 4 to prevent the first limiting portion 114 from moving downward.

It can be understood that connector secondary locking component 4 is optional depending on the required retention force.

Based on the above embodiments, it can be understood that the present disclosure proposes a twisted pair data connector, which can be an angled connector, such as a right-angle connector. Correspondingly, this angled twisted pair data connector comprises a two-piece outer plastic shell structure, which is an outer plastic shell structure obtained by splicing a front shell assembly and a rear cover assembly. The front shell assembly comprises a terminal channel defined therein, and the outer plastic shell structure comprises a cable channel defined therein, wherein the terminal channel and the cable channel are forming an angle. The front shell assembly and the rear cover assembly are assembled together, and the two are sealed by a rear cover sealing body. The rear cover sealing body can be co-molded with the mating-end sealing body, to reduce the number of components and correspondingly reduce production and assembly steps.

The above provides a detailed introduction to a connector provided in the embodiments of the present disclosure. Specific examples are applied in the present disclosure to explain the principles and implementation methods of the present disclosure. The above embodiments are only used to help understand the technical solution and core idea of the present disclosure; Ordinary technical personnel in this field should understand that they can still modify the technical solutions described in the aforementioned embodiments, or equivalently replace some of the technical features; And these modifications or substitutions do not deviate from the essence of the corresponding technical solutions from the scope of the technical solutions of the various embodiments of the present disclosure.

1. A twisted pair data connector, comprising:
a front shell assembly, wherein the front shell assembly comprises a terminal channel defined therein;
a rear cover assembly, the rear cover assembly is to be assembled with the front shell assembly to form an outer plastic shell structure, outer plastic shell structure has a cable channel defined therein, and the cable channel forms an angle with the terminal channel; and
a rear cover sealing body is provided at a joint between the front shell assembly and the rear cover assembly.

2. The twisted pair data connector according to claim 1, wherein the rear cover sealing body is installed and positioned within the front shell assembly.

3. The twisted pair data connector according to claim 1, wherein the front shell assembly comprises an insulation housing and an integral seal, and the rear cover sealing body forms a part of an integrated sealing member.

4. The twisted pair data connector according to claim 3, wherein the integral seal comprises mating-end sealing body arranged in the terminal channel, a rear cover sealing body, and a connecting part connecting the mating-end sealing body and the rear cover sealing body.

5. The twisted pair data connector according to claim 4, wherein the insulation housing and the integral seal are formed by co-molding process, so that the insulation housing and the integral seal are inseparable from each other.

6. The twisted pair data connector according to claim 5, wherein the rear cover assembly comprises a rear cover housing, which is to be latched with the insulation housing, and a seal fitting groove is provided on the rear cover housing to receive the rear cover sealing body of the integral seal.

7. The twisted pair data connector according to claim 1, wherein the twisted pair data connector is a right-angle connector.

8. The twisted pair data connector according to claim 1, wherein the twisted pair data connector is a female connector.

9. The twisted pair data connector as claimed in claim 1, wherein the rear cover assembly comprises a rear cavity to accommodate a cable seal.

10. The twisted pair data connector as claimed in claim 9, wherein the cable seal and the rear cover assembly are formed through a co-molding process.
